(19) United States
(12) Patent Application Publication
(10) Pub. No.: US 2023/0094784 A1
(43) Pub. Date: Mar. 30, 2023

(54) Grill Device

(71) Applicants: Roger Powers, Vicksburg, MS (US); Darrin Powers, Tucker, GA (US)

(72) Inventors: Roger Powers, Vicksburg, MS (US); Darrin Powers, Tucker, GA (US)

(21) Appl. No.: 17/851,092

(22) Filed: Jun. 28, 2022

Related U.S. Application Data
(60) Provisional application No. 63/247,846, filed on Sep. 24, 2021.

(51) Int. Cl. A47J 37/07; F24C 15/08

(52) U.S. Cl. CPC A47J 37/0786; A47J 37/0704; F24C 15/08

(57) ABSTRACT

The present invention relates generally to the field of grills. More specifically, the present invention relates to a grill device that is primarily comprised of a base with at least one wheel and an ash collector, as well as a body further comprised of at least one pull out tray and at least one lid. The device is durable such that it can withstand high temperature differences between its inner and outer surfaces. The device is also comprised of a pull out tray that allows the contents inside the device to be pulled from the device to be flipped, turned, or generally checked on without opening the lid, losing minimal heat to the atmosphere. In this manner, the device can be applied to any grilling or barbecuing setting such that the heat within the device may be evenly distributed to the contents, preventing longer cook times and uneven cooking.

### CROSS-REFERENCE TO RELATED APPLICATION

The present application claims priority to, and the benefit of, U.S. Provisional Application No. 63/247,846, which was filed on Sep. 24, 2021, and is incorporated herein by reference in its entirety.

### FIELD OF THE INVENTION

The present invention relates generally to the field of outdoor grills. More specifically, the present invention relates to an outdoor grill device that is primarily comprised of a base with at least one wheel and an ash collector as well as a body further comprised of at least one pull out tray and at least one lid. The device is durable and rigid such that it can withstand high temperature differences between its inner and outer surfaces. The device is also comprised of a pull out tray that allows the contents inside the device to be pulled from the device to be flipped, turned, or generally checked on without opening the lid, losing minimal heat to the atmosphere. In this manner, the device can be applied to any grilling or barbecuing setting such that the heat within the device may be evenly distributed to the contents, preventing uneven cooking and longer cook times. Accordingly, the present disclosure makes specific reference thereto. Nonetheless, it is to be appreciated that aspects of the present invention are also equally applicable to other like applications, devices and methods of manufacture.

### BACKGROUND

Many individuals enjoying cooking with grills. However, grill clean up can be frustrating, especially for those with charcoal grills. Pieces of meat or other food may drop into the bottom of a charcoal grill which leaves the user without an easy way to clean the grill. Further, grills may lose a large amount of heat when a user checks on the food being cooked inside by lifting the grill lid. Thus, the food may take longer to cook, or may cook unevenly, depending on the position of the food within the grill and the amount of times the lid is opened. In addition, once the food is ready to be taken off the grill, there is often limited space for plates or other serving dishes to be placed or stored near the grill.

Therefore, there exists a long-felt need in the art for an improved grill device. There also exists a long-felt need in the art for a grill device that makes for easy clean-up of both the food cooking surface and the bottom of the grill where ash or other food remnants may remain after cooking has been completed. Further, there exists a long-felt need in the art for a grill device in which the contents inside may be accessed without opening the entire grill, thus preventing the loss of heat. In addition, there exists a long-felt need in the art for a grill with ample space for cooking utensils, plates, and serving dishes for cooking preparation and final presentation.

The subject matter disclosed and claimed herein, in one embodiment thereof, comprises a grill device. The device is primarily comprised of a base with at least one wheel and an ash collector as well as a body further comprised of at least one pull out tray and at least one lid. The device is rigid and durable such that it can withstand high temperatures without being damaged. The device is also comprised of a pull out tray that allows a griller to access the food being cooked without opening the lid of the device and releasing large amounts of heat. In this manner, the device can be applied to any grilling or barbecuing setting such that the heat within the device may be evenly distributed to the contents, preventing uneven cooking and longer cook times.

In this manner, the grill device of the present invention accomplishes all the foregoing objectives and provides an improved means to grill meats and other food items over a charcoal flame. Further, the device permits a user to access the food items inside without removing the lid of the device, which allows for minimal heat loss while cooking, as well as easy cleaning of the device. In addition, the device provides a space to prepare the food in a timely and organized manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a grill device. The device is primarily comprised of a base with at least one wheel and an ash collector, as well as a body further comprised of at least one pull out tray and at least one lid. In differing embodiments, the device may be made of a plurality of materials that may be commonly used for making grills. However, the device is preferably made of a metal. In addition, any surface of the body may be comprised of a plurality of indicia such as patterns, logos, emblems, images, symbols, designs, letters, words, characters, animals, advertisements, brands, etc.

The base of the device provides support for the device while allowing it to be transportable. A frame formed by a bottom wall and side walls form an enclosure where common grill items may be stored. At least one hook may be attached to the frame to provide additional hanging storage for items. Attached to the frame is an at least one wheel on which the device may be rolled and transported. A grease trap may sit on the top of the frame below the body of the device to collect grease and other remnants that leak from the body during cooking. An ash collector may also be attached to the frame to collect ashes from the charcoal to be later deposited into a bucket.

The body of the device is hollow and attached to the top of the frame. A lid attaches to the body via an at least one hinge, allowing the lid to open upwards and a user to access the interior of the body. To further access the interior of the body, at least one tray may be pulled out from the body while the lid remains down to allow a user to access the interior contents of the body with minimal heat loss. A handle on the outside of the body attaches to the tray, allowing it to be pulled out easily. The tray slides into a channel on either side of an interior surface of the body. The channel provides support for the tray as well as an easy access point for it to be placed into and removed from the body of the device. When the tray is fully pushed into the body, a face plate aligns with the outer surface of the body to seal and insulate the contents within. In addition, a tray may be attached to the device that provides a sturdy space for food preparation.

Accordingly, the grill device of the present invention is particularly advantageous as it allows a griller to access food while it is being cooked with minimal heat loss to the atmosphere. Further, the device provides a convenient and customizable space for food to be prepared and placed once finished cooking. In addition, the device permits trays and other components to be easily removed for cleaning and disinfecting. In this manner, the grill device overcomes the limitations of existing grills known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a grill device of the present invention in accordance with the disclosed architecture;

FIG. 2 illustrates an enhanced perspective view of one potential embodiment of a pull out tray of one potential embodiment of the grill device of the present invention in accordance with the disclosed architecture;

FIG. 3 illustrates an enhanced perspective view of one potential embodiment of a pull out tray of one potential embodiment of the grill device of the present invention in accordance with the disclosed architecture; and

FIG. 4 illustrates an enhanced perspective view of one potential embodiment of a grease trap of one potential embodiment of a grill device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved grill device. There also exists a long-felt need in the art for a grill device that makes for easy clean up of both the food cooking surface and the bottom of the grill where ash or other food remnants may remain. Further, there exists a long-felt need in the art for a grill device in which the contents inside may be accessed without opening the entire grill up, thus losing heat to the atmosphere. In addition, there exists a long-felt need in the art for a grill with ample space for cooking utensils, plates, and serving dishes for cooking preparation and final presentation.

The present invention, in one exemplary embodiment, is comprised of a grill device that allows food items to be prepared and cooked over a charcoal flame. The device is primarily comprised of a base with at least one wheel and an ash collector, as well as a body further comprised of at least one pull out tray and at least one lid. The device may also be made of a plurality of differing materials but is preferably made of a metal. In addition, any surface of the body may be comprised of a plurality of indicia such as patterns, logos, emblems, images, symbols, designs, letters, words, characters, animals, advertisements, brands, etc.

Further, the base of the device is comprised of a frame and a grease trap. At least one wheel may be attached to the bottom of the frame, allowing for the device to be easily transported. The frame of the base is further comprised of at least one side wall and a bottom wall in which the side walls and bottom wall form an enclosure where grill items, such as spatulas, pans, and other accessories may be stored. An at least one hook may also be attached to the frame to hang items that may aid in the grilling of food items. The grease trap may be removably attached to the frame such that it can easily be removed for disposal of grease and cleaning. The grease trap may sit directly below the body of the device to catch any remnants of food items that may fall through the body. In addition, an ash collector may be fixedly or removably attached to the frame of the device, the body of the device, or both the frame and the body. The ash collector may accept ash from charcoal used in the body of the device. A door that is sealed by a latch may open to empty the contents of the ash collector downwards onto the ground or into a separate collection bin, such as a bucket, for disposal later.

The body of the device may be hollow and made of metal, but also be comprised of an insulating material to lessen the amount of heat loss while cooking food items. The body may be fixedly or removably attached to the top of the frame such that it sits above the frame. At least one temperature gauge may be attached to an outer surface of the body, indicating the temperature inside of the body. Further, a smoke stack may extend upwards out of the body to expel smoke from the charcoal burning inside of the body. A lid may be attached to the body via an at least one hinge that allows the lid to open upwards so a user may see and interact with the food items inside the body. In addition, a tray may attach to the device via an at least one pin such that the tray may swivel about the axis of the pin to provide a convenient space for food preparation and presentation while cooking.

An at least one handle may extend outwards from the outer surface of the body. The handle may be fixedly attached to an at least one tray and a face plate. The face plate of the handle near seamlessly lines up with the lid, such that when the handle is pushed in, minimal heat and air may escape through the joint line between the lid and the face plate of the handle. The tray of the handle may be used to hold the food items or the charcoal that is used to cook the food items. In differing embodiments, the body may be comprised of multiple trays with handles in which one may hold charcoal while the remaining hold food items. Further, the handle may be accessible from any location on the outer surface of the body. In differing embodiments, the tray may be pulled out of the body by a handle on the back of the body as well as the front. The tray may be elevated from the bottom of the body. In differing embodiments, the interior surface of the body may be comprised of an at least one channel in which the tray may be supported. The tray may slide into and out of the channel for ease of access to the food items being cooked.

Accordingly, the grill device of the present invention is particularly advantageous as it allows a griller to access food while it is being cooked with minimal heat loss to the atmosphere. Further, the device allows for components to be easily removed for disinfecting and cleaning when necessary. In addition, the device provides a customizable and convenient space for food preparation as well as presentation once finished cooking. Therefore, the device decreases the likelihood of uneven cooking due to an uneven distribution of heat throughout the device.

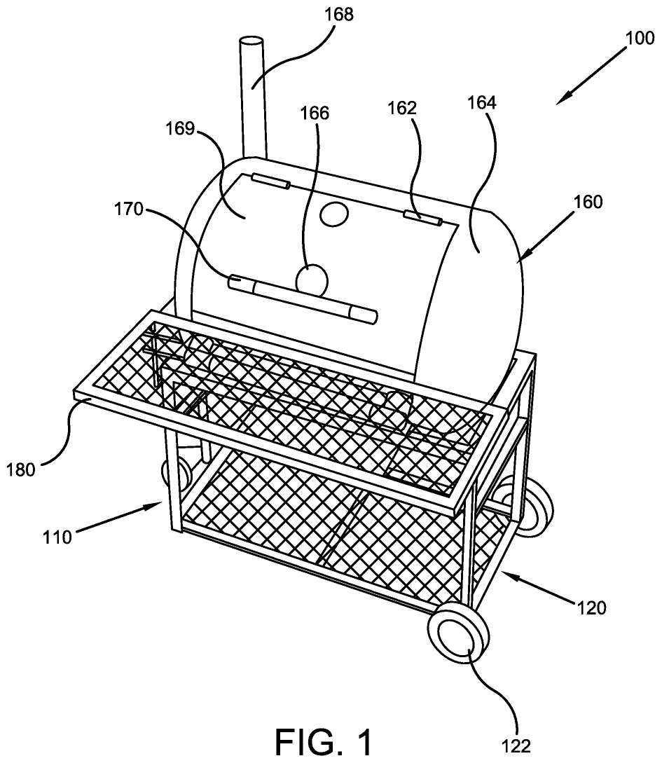

Referring initially to the drawings, FIG. 1 illustrates a perspective view of one potential embodiment of a grill device 100 of the present invention in accordance with the disclosed architecture. The device is primarily comprised of a base 110 with at least one wheel 122 and an ash collector 140 as well as a body 160 further comprised of at least one pull out tray 172 and at least one lid 169. In differing embodiments, the device 100 may be made of a plurality of materials, such as wood, ceramics, or plastic, but is preferably made of a metal such as, but not limited to: steel, stainless steel, carbon steel, alloy steel, wrought iron, cast iron, aluminum, magnesium, copper, brass, bronze, zinc, titanium, tungsten, nickel, cobalt, etc. In addition, any surface of the base 110 or body 160 may be comprised of a plurality of indicia such as patterns, logos, emblems, images, symbols, designs, letters, words, characters, animals, advertisements, brands, etc.

The base 110 of the device 100 is further comprised of a frame 120, at least one wheel 122, at least one grease trap 130, at least one ash collector 140, and at least one hook 150. The wheels 122 may be fixedly or removably attached to the frame 120 such that the wheels 122 extend past a bottom wall 126 of the frame 120 to allow the device 100 to be transported with minimal resistance due to friction. The frame 120, further comprised of vertical side walls 124 and a horizontal bottom wall 126, provides support for the device 100 and provides an interior space for storage of items such as, but not limited to: charcoal bags, lighters, spatulas, plates, serving dishes, tongs, general cookware items and grill supplies, etc.

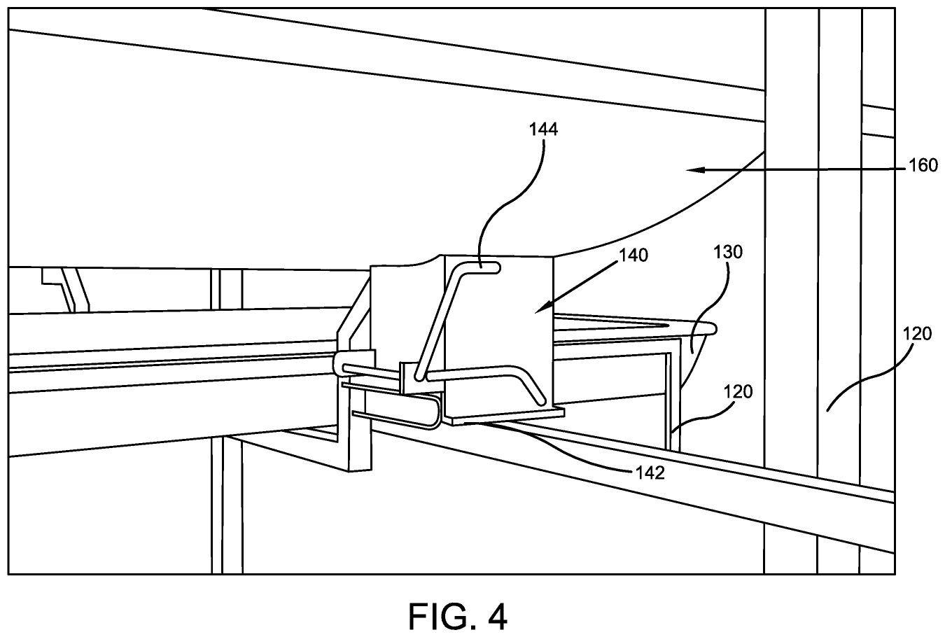

FIG. 4 illustrates an enhanced perspective view of one potential embodiment of a grease trap of one potential embodiment of a grill device 100 of the present invention in accordance with the disclosed architecture. The grease trap 130 may rest on the top or attach to a portion of the frame 120 and/or side walls 124 below the body 110 of the device 100 such that it can be easily removed for cleaning or replaced. The grease trap 130 collects any food remnants that spill through the body 160 of the device 100. In addition, an ash collector 140 may be attached to the frame 120, the body 160, or both 120, 160 to collect ash that accumulates at the bottom of the body 160 from the charcoal 10. The ash collector 140 is further comprised of a door 142 that opens via a latch 144 to empty its contents to the ground or bucket below. The hooks 150 may be fixedly or removably attached to the frame 120 and allow a user to hang items, such as spatulas, out of the way when not in use but within reachable distance for when they are needed. In one potential embodiment, the hooks 150 may clip onto the frame 120 in such a way that a user can customize the location of the hooks 150 as most appropriate for the needs of the user.

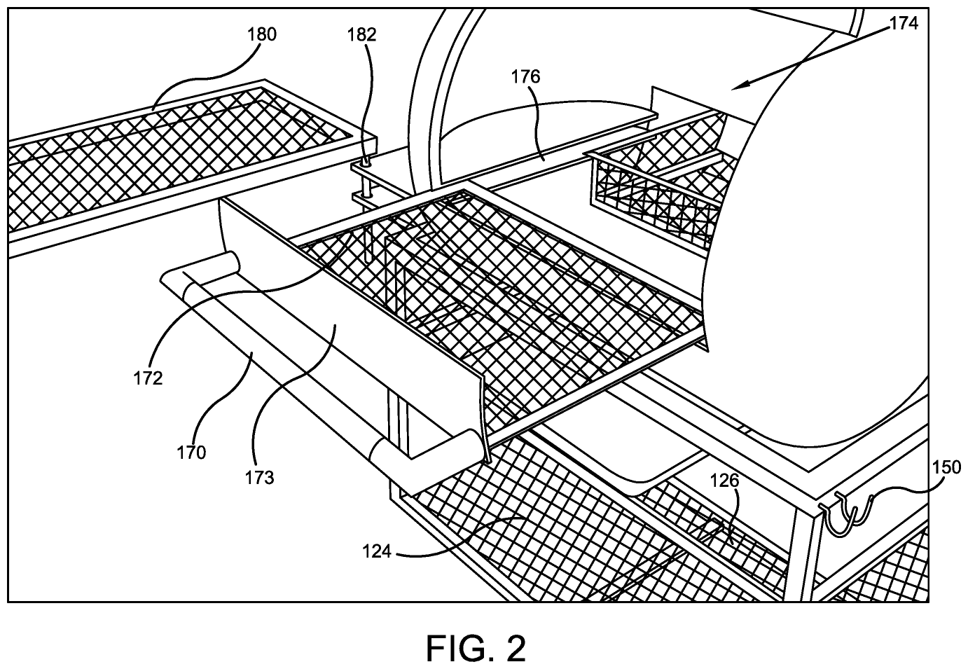

The body 160 of the device 100 may be hollow to allow for cooking to occur inside of the body 160. In one potential embodiment, the body 160 may be further comprised of an insulating material to minimize heat loss to the atmosphere during cooking. To access the inside of the body 160, a lid 169 may attach to the body 160 via an at least one hinge 162, allowing the lid 169 to raise upwards. At least one temperature gauge 166 may be attached to the outer surface 164 of the body 160. The temperature gauge 166 may indicate to a user the internal temperature of the body 160 when the lid 169 is closed. Further, at least one smoke stack 168 extends vertically out of the top of the body 160 to allow smoke from the burning charcoal 10 to escape from the body 160. In addition, a tray 180 may be fixedly or removably attached to the frame 120 of the base 110 or the body 160 via an at least one pin 182 such that it provides a working area for food preparation, as seen in FIG. 2. The tray 180 may rotate about the vertical axis of the pin 182, allowing the user to change its location and orientation as needed. The pin 182 may also lock in one embodiment.

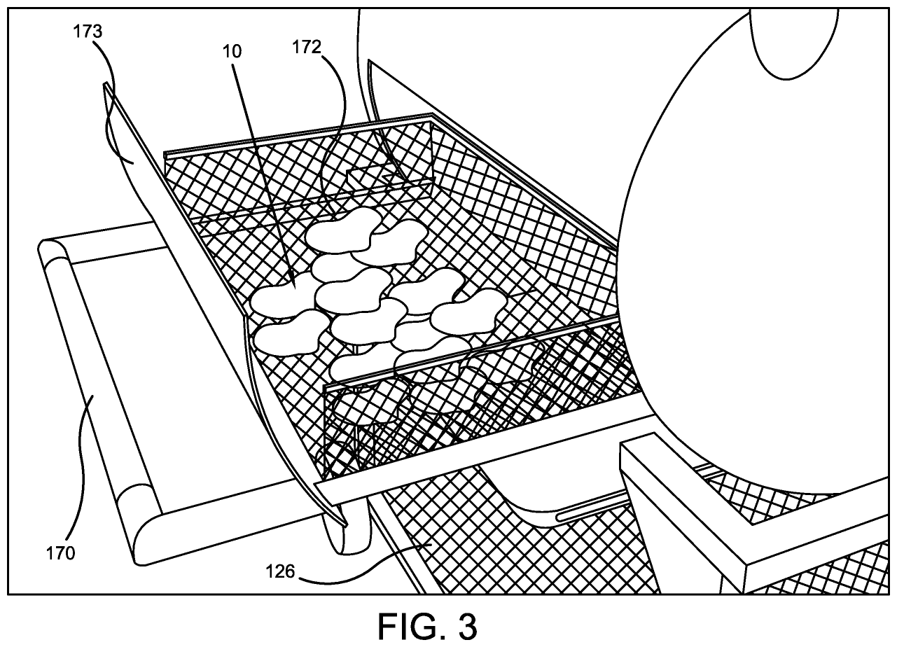

Apart from lifting the lid 169 to access the inside of the body 160, a user may also pull on an at least one handle 170 to pull out at least one tray 172 from the inside of the body 160 without lifting the lid 169, as also seen in FIG. 2. The handle 170 may be made of a material that is a poor conductor of heat such as, but not limited to, a wood, glass, rubber, Teflon, silicone, etc. The tray 172 may form a generally basket-like shape with sides to enclose its contents or the tray 172 may be flat without sides. When the handle 170 is fully pushed into the body 160, a face plate 173 integrates into the outer surface 164 of the body 160 to insulate the contents inside by creating an airtight seal with the rest of the body 160. In differing embodiments, the body 160 may be comprised of a differing number of trays 172. Each tray 172 may be accessed by pulling on its own individual handle 170 or a single handle 170 may pull out multiple trays 172. In addition, a tray 172 may be able to be pulled out of the body 160 at any orientation or in any direction in differing embodiments. Further, each tray 172 may be used for different purposes, such as the bottom-most tray 172 being used to hold charcoal 10 (as best seen in FIG. 3) while the other trays 172 may be used to hold food items. The tray 172 may be supported by sliding into a channel 176 on each side of an interior surface 174 of the body. In differing embodiments, there may be channels 176 at differing heights to allow better heat control by distancing the food items from the flame of the charcoal 10. In one potential embodiment, the channel 176 may be ribbed near its end to prevent the tray 172 from easily sliding out of the body 160.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “grill device” and “device” are interchangeable and refer to the grill device 100 of the present invention.

Notwithstanding the foregoing, the grill device 100 of the present invention and its various components can be of any suitable size and configuration as is known in the art without affecting the overall concept of the invention, provided that they accomplish the above-stated objectives. One of ordinary skill in the art will appreciate that the size, configuration and material of the grill device 100 as shown in the FIGS. are for illustrative purposes only, and that many other sizes and shapes of the grill device 100 are well within the scope of the present disclosure. Although the dimensions of the grill device 100 are important design parameters for user convenience, the grill device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grill device comprising:
a base comprised of a frame, a tray that attaches to the frame via a pin, a wheel, a side wall and a bottom wall;
a body comprised of a lid, a temperature gauge, a smoke stack, a handle, a pull out tray, and a face plate;
an ash collector; and
a grease pan.

2. The grill device of claim 1, wherein the body is attached to the base.

3. The grill device of claim 1, wherein the smoke stack extends vertically out of the body.

4. The grill device of claim 1, wherein the grease pan is located below the body.

5. A grill device comprising:
a base comprised of a frame, a tray that is attached to the frame via a vertical pin, a wheel, a side wall, a hook and a bottom wall;
a body comprised of a lid, a temperature gauge, a smoke stack, a handle, a pull out tray and a face plate;
an ash collector; and
a grease pan.

6. The grill device of claim 5, wherein the body is attached to the base.

7. The grill device of claim 5, wherein the side wall and bottom wall create an interior space.

8. The grill device of claim 5, wherein the grease pan is removably attached to the frame.

9. The grill device of claim 5, wherein the ash collector is further comprised of a door.

10. The grill device of claim 9, wherein the ash collector is further comprised of a latch.

11. The grill device of claim 10, wherein the latch opens the door.

12. The grill device of claim 5, wherein the hook removably clips to the frame.

13. A grill device comprising:
a base comprised of a frame, a tray attached to the frame via a vertical pin, a wheel, a side wall, a hook and a bottom wall;
a body comprised of a lid, a smoke stack and a handle;
an ash collector; and
a grease pan.

14. The grill device of claim 13, wherein the body is attached to the base.

15. The grill device of claim 13, wherein the tray rotates around a vertical axis of the vertical pin.

16. The grill device of claim 15, wherein the vertical pin comprises a lock.

17. The grill device of claim 13, wherein the body further comprises a pull out tray having a handle.

18. The grill device of claim 17, wherein the pull out tray is received by a channel on an interior surface of the body.

19. The grill device of claim 13, wherein the body further comprises a face plate that forms an airtight seal with the body.

20. The grill device of claim 13, wherein the wheel is removably attached to the frame.
